(19) United States
(12) Patent Application Publication
(10) Pub. No.: US 2002/0153369 A1
(43) Pub. Date: Oct. 24, 2002

(54) Induction fluid heating system

(75) Inventor: Motoaki Uemura, Osaka (JP)

Correspondence Address: H. Michael Brucker, Suite 110, 5855 Doyle Street, Emeryville, CA, 94608, US

(73) Assignee: Daihan Corporation

(21) Appl. No.: 09/840,597

(22) Filed: Apr. 23, 2001

(51) Int. Cl. H05B 6/10

(52) U.S. Cl. 219/628; 219/672

(57) ABSTRACT

A fluid heating system in which the electromagnetic field on both sides of a single induction work coil is utilized to heat two separate but connected chambers simultaneously.

### FIELD OF THE INVENTION

The present invention relates to novel and useful induction heating systems and, in particular, to such heating systems for fluid heating and steam generation.

### BACKGROUND OF THE INVENTION

In my U.S. Pat. No. 5,773,797, I teach a steam generating system in which a first induction coil is powered to heat water in a first chamber producing saturated steam that is directed to a second chamber where a second induction coil is powered to superheat the steam. The teachings of that patent, to the extent relevant to the invention described herein, are incorporated herein by reference as if fully set forth.

In the present invention, I teach a fluid heating and steam generating system in which a single induction coil is disposed to heat the contents of two chambers simultaneously, thereby achieving results in a highly efficient manner.

### SUMMARY OF THE INVENTION

While prior art induction coil heating systems typically use only a portion of the electromagnetic field from an induction work coil for heating, and shield or otherwise prevent the rest of the field from inadvertently heating elements not meant to be heated, the present invention uses substantially all of the field from a coil for productive heating. By strategically locating an induction work coil between two heating chambers or elements, the present invention teaches apparatus and methods by which the field from a single induction coil simultaneously heats two separate chambers and thereby achieves the primary goal of the invention.

Accordingly, it is an object of the present invention to produce heating in two chambers with a single induction work coil wherein substantially all of the field from the coil is used for productive heating.

The invention possesses other objects and advantages, especially as concerns particular characteristics and features thereof which will be better understood from the following detailed description of the preferred embodiments when read in conjunction with the appended drawing figures.

### BRIEF DESCRIPTION OF THE DRAWINGS

FIG. 1 is a sectional side view of one embodiment of the invention in which an electromagnetic field from a single coil causes heat to be generated in two separate chambers simultaneously;

FIG. 2 is a sectional side view of an alternative embodiment to FIG. 1 with a different steam discharge port;

FIG. 3 is a sectional side view of an alternative embodiment of the invention of FIG. 2 wherein heating elements are disposed in each of the separate chambers;

FIG. 4 is a sectional side view of an alternative embodiment of the invention used as a boiler in which the separate chambers are concentric cylinders;

FIG. 5 is a top view of FIG. 4 taken along the line A-A;

FIG. 6 is a sectional side view of an alternative embodiment of the invention in which heating cores are disposed in chambers which are concentric cylinders; and

FIG. 7 is a top view of FIG. 6 with a portion broken away to better illustrate the interior.

### DETAILED DESCRIPTION OF THE PREFERRED EMBODIMENTS

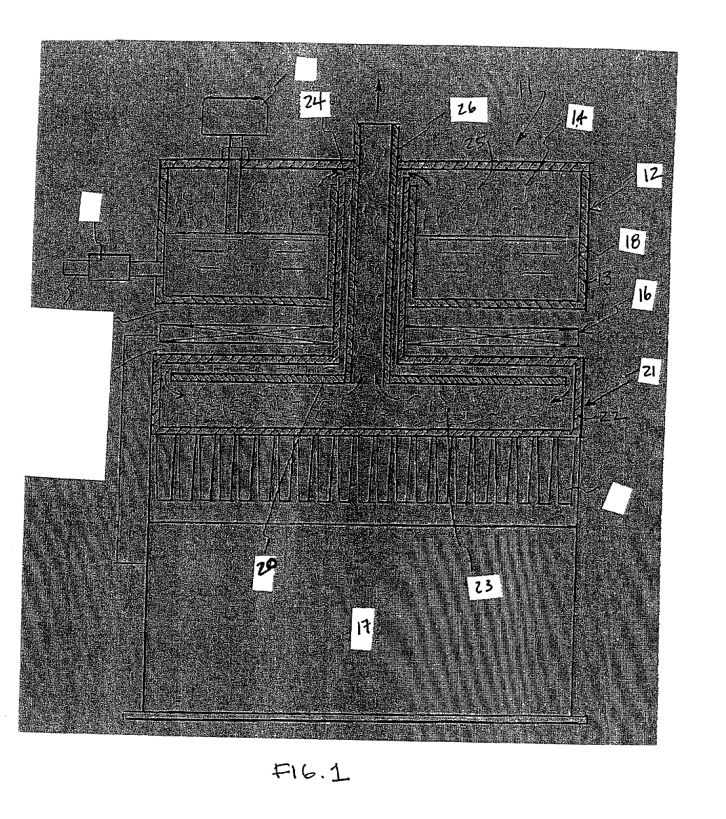

Referring to FIG. 1, in one embodiment of the invention, a heating system 11 includes a first heating chamber 12 having walls 13 and an interior space 14 disposed in the proximity of an induction work coil 16. The electromagnetic field from the coil 16 (not shown), when it is energized by an RF source 17, interacts with and causes heating eddy currents in the wall 13 of chamber 12, causing heat to be generated and transferred to the interior 14 of the chamber 12. Fluid, such as water 18, contained in the chamber 12 is thereby heated. A second heating chamber 21 having walls 22 and an interior space 23 is also disposed in the proximity of the induction work coil 16 so that its electromagnetic field interacts with the chamber wall 22 inducing eddy currents therein which produce heat which is transferred to the chamber interior 23.

A conduit 24 connects the interior 14 of chamber 12 with the interior 23 of chamber 21 by which steam 25 formed in chamber 12 can migrate into chamber 21 where it can be superheated before exiting through exit channel 26. A deflection plate 20 attached to channel 26 where it opens into chamber 21 causes the steam from chamber 12 to dwell in chamber 21 long enough to be superheated before exiting through channel 26. The deflector plate 20 has the general shape of the chamber 21 and sized to leave an opening between its perimeter (or at least a portion thereof) and the chamber wall 22 through which steam can enter that portion of chamber 21 from which it can directly exit channel 26.

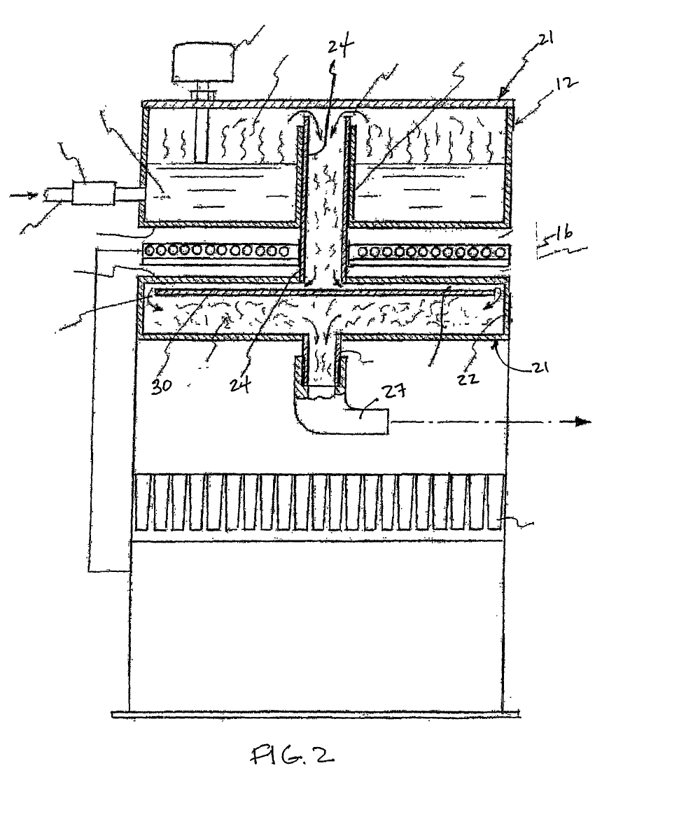

In this embodiment of the invention, both the conduit 24 and the channel 26 pass through the middle of induction work coil 16, although other configurations are within the scope of the invention as illustrated in FIG. 2.

Providing water 18 to first chamber 12 and maintaining a proper water level are all well within the skills of the art, as well as fully explained in my U.S. Pat. No. 5,773,797.

A primary advantage of the present invention is that the electromagnetic field (not shown) induced in induction work coil 16 is used to simultaneously heat the interior spaces 14 and 23 of the two heating chambers 12 and 21, respectively.

Referring to FIG. 2, in an alternative embodiment of the invention, an exit channel 27, rather than passing through the center of the induction work coil 16, extends out the bottom of the second chamber 21. In all other respects, the embodiments are the same, and, in particular, the first heating chamber 12 and the second heating chamber 21 are disposed relative to the induction work coil 16 so that both interact with the electromagnetic field established in the coil 16 to produce heating within both chambers 12 and 21. A deflection plate 30 adjacent the conduit 24 where it opens into chamber 21 causes the steam from chamber 12 to dwell in chamber 21 long enough to be superheated.

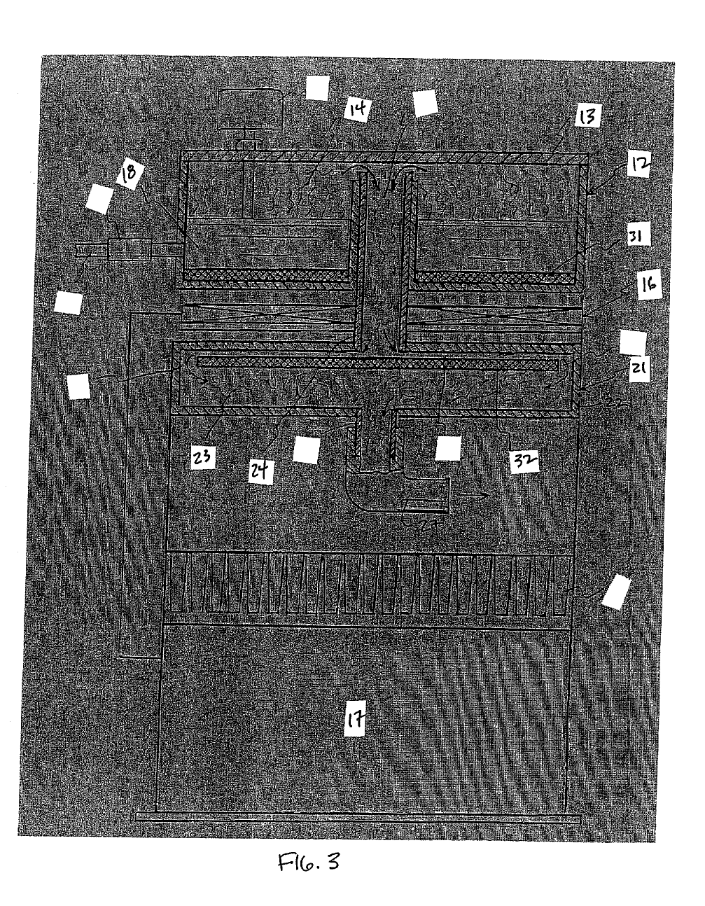

Referring to FIG. 3, in this embodiment of the invention, as in the two previously described embodiments, the first chamber 12 and the second chamber 21 are both disposed relative to the induction work coil 16 so that they interact with the electromagnetic field produced by the coil 16 when energized by the RF source 17.

In this embodiment, however, the walls 13 and 22 of the chambers 12 and 21, respectively, are not made of a material in which eddy currents or other heating activity occurs by virtue of interaction with an electromagnetic field. Instead, a heating element 31 is disposed within the interior 14 of the first chamber 12 and a similar heating element 32 is disposed within the interior 23 of the second chamber 21. Heating elements 31 and 32 are made of a ferrous or other induction capable material in which heating eddy currents are induced by the electromagnetic field produced by the induction work coil 16. Material most advantageously used for the heating elements 31 and 32 are carbon and carbon plate. In this embodiment, the heating element 32 also functions as a deflector as described above in connection with deflector 20.

Thus, in this embodiment, as the electromagnetic field from the induction work coil 16 induces eddy currents in heating elements 31 and 32, the water 18 in the first chamber is heated into steam which passes through conduit 24 to the second chamber 21 where it is further heated into superheated steam which then exits through channel 27 in the bottom of the second chamber 21.

Once again, the single heating coil 16 is positioned so that its electromagnetic field interacts with and causes heating in both the first chamber 12 and the second chamber 21.

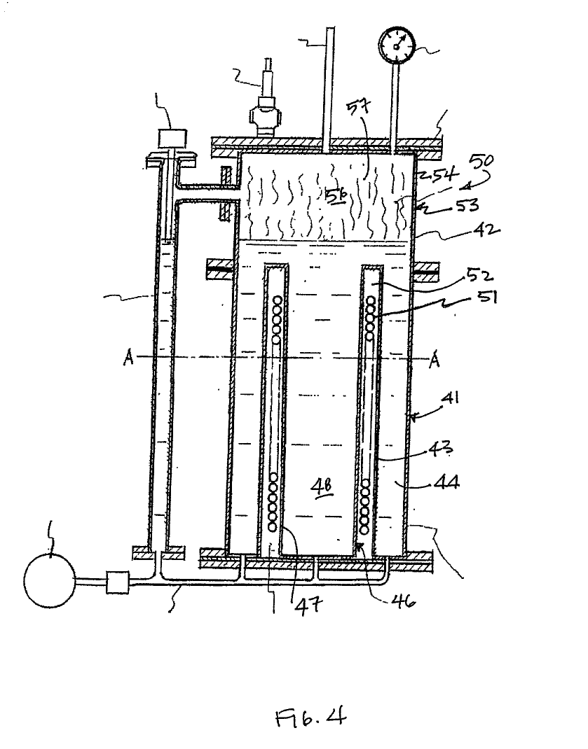

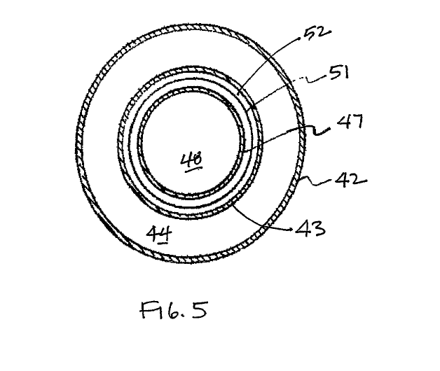

Referring to FIGS. 4 and 5, a boiler 50 embodying the present invention has a first chamber 41 formed by cylindrical, spaced-apart walls 42 and 43 defining an interior space 44. Chamber 41 surrounds a second chamber 46 formed by a circular wall 47 defining an interior space 48. In a space 52, between chambers 41 and 46, is an induction work coil 51 which, when powered by an RF source (not shown), induces eddy currents in the walls 43 and 47 thereby producing heat in the chambers 41 and 46. A third chamber 53 formed by wall 54, which can be an extension of wall 42, and defining interior space 56 forms a means for connecting the interior spaces 44 and 48 of chambers 41 and 46, respectively.

Once again, the coil 51 is disposed relative to the two chambers 41 and 46 so that both are heated simultaneously to heat the fluid in chambers 41 and 46 by the efficient use of induction work coil 51. When the fluid is water or the like, steam is produced.

The steam from space 56 can be used for a variety of commercial purposes, such as, for example, processing foods. The invention is useful for a water heater (boiler), steam generator, thermal fluid heater or fryer, to name just a few. In all cases, the present invention provides the advantage of efficiency in the use of energy.

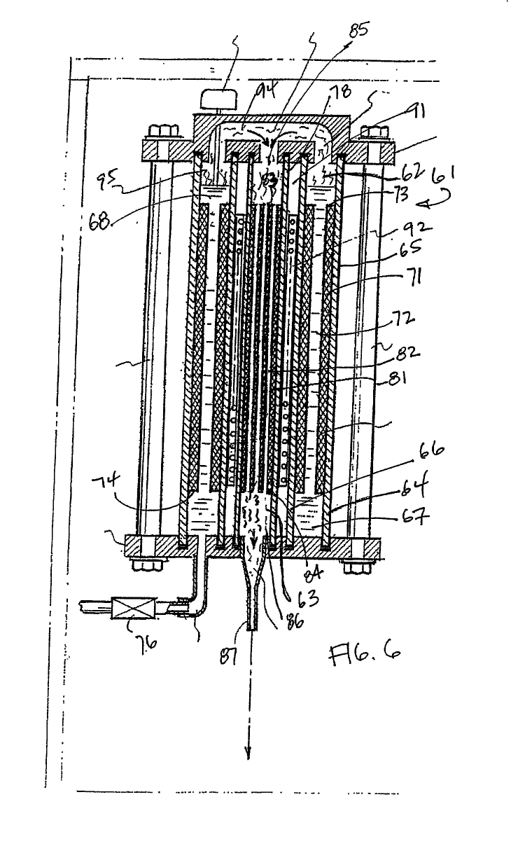

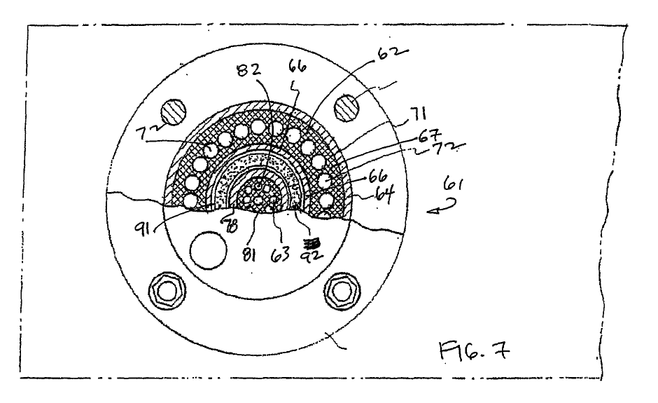

Referring to FIGS. 6 and 7, in this embodiment of the invention, a system 61 for producing superheated steam includes a cylindrical outer chamber 62 which surrounds an inner cylindrical chamber 63. The outer chamber 62, has a cross-section in the shape of a torus, formed by outer cylindrical wall 64 and concentrically spaced-apart inner wall which define an interior space 67 which is supplied with water 68 by a valve 76. The level of the water 68 is maintained at a predetermined level in a manner well known in the art and which need not be described herein.

Disposed within the interior space 67 of chamber 62 is a cylindrical heating core 71 having a toroidal cross-section and formed of a ferrous or other induction capable material having a plurality of channels 72 formed therein which run longitudinally from the top 73 to the bottom 74 of the heating core 71, providing pathways by which water introduced by pump 76 can flow from the bottom of outer chamber 62 to the top of that chamber.

The concentric inner chamber 63 is formed by a cylindrical wall 78 that is co-axial with first chamber walls 64 and 66 and spaced apart from wall 66.

A cylindrical inner core member 81 is disposed within the inner chamber 63 and is formed from a ferrous or other induction capable material. A plurality of channels 82 extend from the top 83 to the bottom 84 of the core 81 and provide pathways for steam to pass from the upper portion 85 of inner chamber 63 to the lower portion 86 of chamber 63 from which the steam can exit through channel 87 that connects with the inner chamber 63.

Disposed in the space 91 between the outer chamber wall 66 and the inner chamber wall 78 is an induction work coil 92 which, when energized by an RF source (not shown), produces an electromagnetic field that simultaneously causes the inner core member 81 and the outer core member 71 to generate heat.

As previously explained and is well known in the art, the electromagnetic field induces eddy currents in the core members 81 and 71 producing heat. The water 68 in the outer chamber 62 is heated to produce steam which rises into a third chamber 94 which connects the outer chamber 62 to the inner chamber 63. The steam 95 formed in the outer chamber 62 passes into the inner chamber 63 and is superheated by the core member 81 and is eventually discharged through channel 87 as superheated steam.

While heating cores 71 and 81 are described in connection with this embodiment of the invention, it will occur to those skilled in the art that the invention could operate without these cores when the chamber walls are heated by an electromagnetic field, as previously described in connection with other embodiments.

Once again, the invention provides an efficient use of the induction work coil 92 by disposing the heating chambers relative thereto so that the electromagnetic field produced by the coil produces heat in both chambers simultaneously.

It will be apparent to those skilled in the art that various changes, modifications and alterations in the teachings of the present invention may be contemplated without departing from the intended spirit and scope thereof.

As such, it is intended that the present invention only be limited by the terms of the appended claims.

1. In a heating system, the combination comprising:
a first heating chamber having an interior;
a second heating chamber having an interior;
means connecting the interiors of said first and second chambers; and
an induction work coil disposed between said first and second chambers, said induction work coil, when energized, producing an electromagnetic field which induces heating in both said first and second chambers.

2. In the heating system of claim 1, wherein said means connecting the interiors of said first and second chambers is a third chamber.

3. In the heating system of claim 1, wherein said means connecting the interiors of said first and second chambers is a conduit that passes through said induction work coil.

4. In the heating system of claim 1, wherein said first chamber is within said second chamber.

5. In the heating system of claim 2, wherein said first chamber is within said second chamber.

6. In the heating system of claim 1, said first chamber is further described as having a wall and said second chamber is further described as having a wall wherein said walls are disposed in relationship to said induction work coil such that an eddy current is induced in said walls by the electromagnetic field from said induction work coil when it is energized.

7. In the heating system of claim 2, said first chamber is further described as having a wall and said second chamber is further described as having a wall wherein said walls are disposed in relationship to said induction work coil such that an eddy current is induced in said walls by the electromagnetic field from said induction work coil when it is energized.

8. In the heating system of claim 3, said first chamber is further described as having a wall and said second chamber is further described as having a wall wherein said walls are disposed in relationship to said induction work coil such that an eddy current is induced in said walls by the electromagnetic field from said induction work coil when it is energized.

9. In the heating system of claim 1, the combination further comprising:
a heating plate in one of said first and second chambers, said heating plate disposed in relationship to the electromagnetic field of said coil when said coil is energized such that an eddy current is induced in said heating plate by the electromagnetic field.

10. In the heating system of claim 1, the combination further comprising:
a heating plate in both of said first and second chambers, said heating plates disposed in relationship to the electromagnetic field of said induction work coil when said coil is energized such that an eddy current is induced in both said heating plates by the electromagnetic field.

11. In the heating system of claim 9, wherein said heating plates include carbon plate.

12. In the heating system of claim 10, wherein said heating plates include carbon plate.

13. In the heating system of claim 1, wherein said first chamber is further described as containing water and when said induction work coil is energized, said water is heated in said first chamber into steam that passes through said means connecting the interiors of said first and second chambers into said second chamber where it is further heated.

14. In the heating system of claim 13, wherein said steam is further heated into superheated steam in said second chamber.

15. In the heating system of claim 2, wherein said chambers are further described as containing water that is heated in said chambers.

16. In the heating system of claim 15, wherein that water in said first and second chambers is heated to create steam in said third chamber.

17. In the heating system of claim 4, wherein said first chamber is a cylinder having a toroidal cross-section and said second chamber is a cylinder disposed within and spaced apart from said first chamber.

18. In the heating system of claim 17, wherein said induction work coil is disposed in the space between said first and second chambers.

19. In the heating system of claim 18, further comprising;
a first heating core in said first chamber; and
a second heating core in said second chamber.

20. In the heating system of claim 19, wherein;
said first heating core is a cylinder having a toroidal cross-section; and
said second heating core is a cylinder.

21. In the heating system of claim 20, wherein each of said first and second cores are further described as having a first end and a second end, further comprising:
channels in said first heating core allowing fluid to pass from its first end to its second end; and
channels in said second heating core allowing steam to pass from its first end to its second end.
